(19) United States
(12) Patent Application Publication
(10) Pub. No.: US 2004/0016598 A1
(43) Pub. Date: Jan. 29, 2004

(54) Scaffold ladder

(76) Inventor: Mark Verdijk, Belsele (BE)

Correspondence Address: BACON & THOMAS, PLLC, 625 SLATERS LANE, FOURTH FLOOR, ALEXANDRIA, VA, 22314

(21) Appl. No.: 10/602,616

(22) Filed: Jun. 25, 2003

(30) Foreign Application Priority Data
Jul. 10, 2002 (BE) 2002/0434

(51) Int. Cl. E06C 1/36

(52) U.S. Cl. 182/100; 182/93; 182/206

(57) ABSTRACT

Scaffold ladder, that consists of a vertical support provided with rungs on the one hand, and with protruding parts or hook elements on the other hand which can co-operate with the erected scaffold elements.

### BACKGROUND OF THE INVENTION

1. Field of the Invention

The present invention concerns a scaffold ladder.

2. Discussion of the Related Art

It is known that scaffolds, in particular metal tube scaffolds, are usually built by fixing vertical and horizontal tubes in relation to one another by means of clamping pieces, whereby also what are called cross bracings are applied, in order to obtain a solid construction upon which one can work to erect and/or work on other constructions, buildings or the like, for example in the case of embellishments, reparations and the like.

Next, working platforms are provided at different heights of such a scaffold construction upon which the scaffold builder and/or the workers working at or on such constructions can move.

During the erection of such scaffolds as well as during the use of these scaffolds, it is required that there is a possibility to move vertically.

Such a movement is often obtained, especially while building the scaffolds, as the scaffold builders climb up via the scaffold elements that have already been erected, which is against the rules, however, and which moreover is extremely dangerous.

In order to avoid such situations, ladders are used which are provided on the outside of scaffolds that have already been built or have been partially built, by means of tubes and clamps which are fixed to these scaffolds.

These ladders are disadvantageous, not only in that they are provided on the outside of the scaffold, but also in that they can only be provided after a part of the scaffold has been erected, so that there still remains a distance in the height which has to be bridged without any ladders, meaning that a danger zone still remains, be it to a lesser degree.

### SUMMARY OF THE INVENTION

The invention aims a scaffold ladder offering several advantages in relation to the known embodiments whereby the above-mentioned and other disadvantages are excluded.

To this end, the scaffold ladder according to the invention consists of a vertical support provided with rungs on the one hand, and with protruding parts or hook elements on the other hand which can co-operate with the erected scaffold elements.

As the scaffold ladder is provided with hook elements which can work in conjunction with the existing scaffold elements, this offers the advantage that the scaffold ladder can be provided and removed again in a fast, simple and safe manner.

Moreover, this scaffold ladder according to the invention offers the advantage that no extra material such as tubes, clamps or the like have to be used.

Another advantage of a scaffold ladder according to the invention is that it is provided on the inside of the scaffold, which is very safe compared to a ladder which is provided on the outside of the scaffold.

As, while scaffolds are being erected, the scaffold ladder can be fixed and removed again in a fast manner, the scaffold builder will automatically use this ladder instead of climbing up along the already erected scaffold.

The scaffold ladder preferably consists of at least one vertical support onto which are fixed V-shaped brackets at regular distances in between which rungs are provided at the free ends of said brackets, whereby the vertical support is provided with hook elements which can work in conjunction with the flanges which are traditionally provided on the vertical tubes of such scaffolds and which are provided with-holes.

According to a preferred embodiment, the scaffold ladder according to the invention comprises a lock in order to make sure that the scaffold ladder can be fixed to the scaffold in a stable and safe manner.

Although such a ladder is in the first place meant to be used only during the assembly and disassembly of the scaffold concerned, it can of course also be used permanently, whereby, in the latter case, passages are provided in the working platforms at the height of the ladder.

### BRIEF DESCRIPTION OF THE DRAWINGS

In order to better explain the characteristics of the invention, the following preferred embodiment of a scaffold ladder according to the invention is described as an example only without being limitative in any way, with reference to the accompanying drawings, in which:

FIG. 1 represents a schematic view in perspective of a tube scaffold which is provided with a ladder according to the invention;

FIG. 2 represents the part indicated with F2 in FIG. 1 to a larger scale;

FIG. 3 represents the part indicated with F3 in FIG. 1 to a larger scale;

FIG. 4 represents a section according to line IV-IV in FIG. 2;

FIG. 5 represents a section according to line V-V in FIG. 2;

FIG. 6 represents a section according to line VI-VI in FIG. 3.

### DESCRIPTION OF THE PREFERED EMBODIMENT

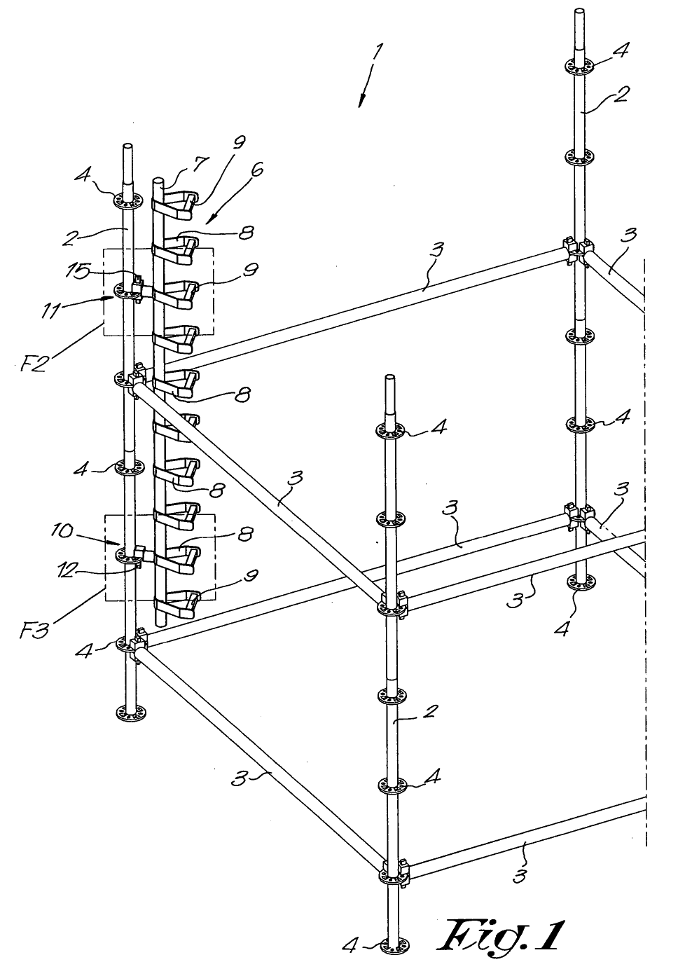

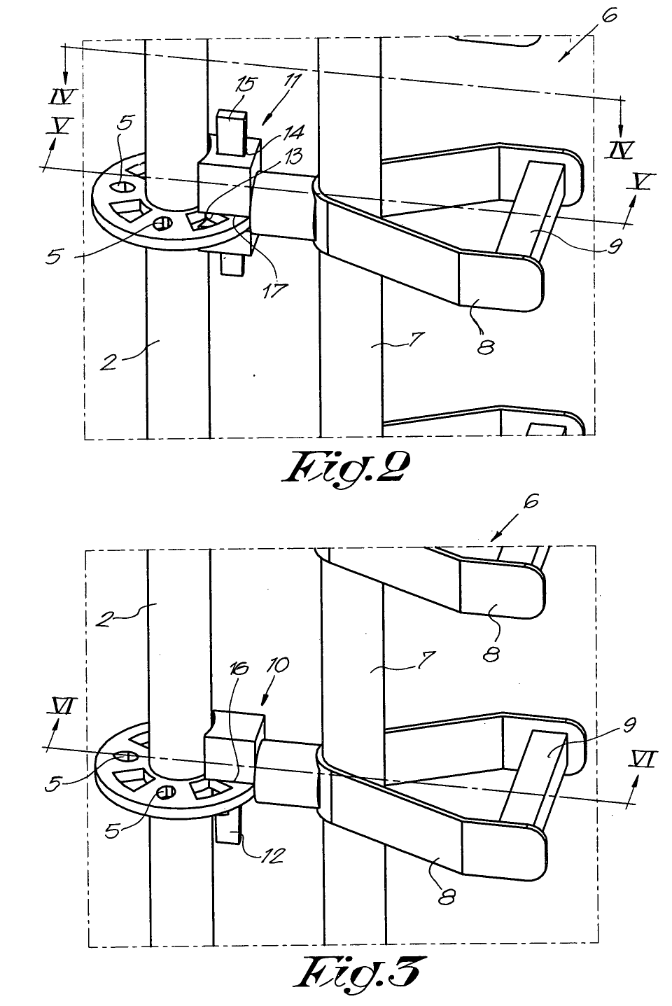

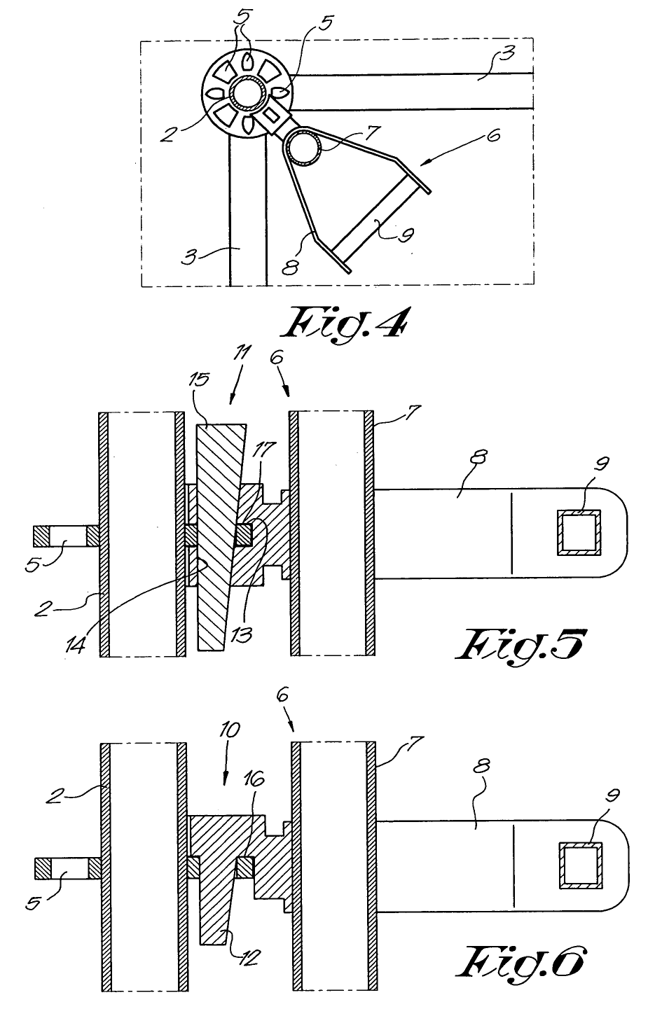

FIG. 1 represents a partial scaffold 1 which consists in the known manner of a number of tubular vertical scaffold elements 2 and tubular horizontal scaffold elements 3.

The vertical scaffold elements 2 are, as usual, provided with ring-shaped flanges 4 at certain distances, in which are provided a number of holes 5.

The horizontal scaffold elements 3 and possible cross bracings which are not represented in the drawings can be anchored in the holes 5 of said flanges 4 in the known manner by means of fixing elements on the far ends of said scaffold elements 3, cross bracings respectively.

The scaffold ladder 6 according to the invention comprises at least one vertical support 7, preferably in the shape of a tube, whereby the length of the vertical support 7 will be preferably somewhat larger than the distance of at least four flanges 4 of a vertical scaffold element 2.

Naturally, the length of the vertical support 7 will be as a function of the application. Thus, for example, in the case of larger gaps between the horizontal scaffold elements 3, the support 7 and thus the scaffold ladder 6 will be made longer.

In this embodiment, the vertical support 7 is provided with V-shaped brackets 8, fixed at suitable, regular distances from one another on the vertical support 7, for example by means of welding, whereby, between the free ends of these V-shaped brackets 8, are provided rungs 9.

On the support 7 are further fixed two protruding parts or hook elements 10 and 11 situated on the opposite side of the V-shaped brackets 8.

On the free end of the lower protruding part 10 is provided a downward directed pen 12 which is preferably made wedge-shaped and whose largest cross dimension is equal to or somewhat smaller than a hole 5 of a flange 4.

The top protruding part 11 is provided with a groove 13 which fits over a flange 4, and it is further provided with a vertical key-shaped passage 14 which is tapered and in which fits a removable, wedge-shaped pen 15.

Naturally, the width of the groove 13 is larger than the thickness of the aforesaid flange 4, whereas the vertical key-shaped passage 14 has a cross dimension at the height of the aforesaid groove 13 which is more or less equal to the cross dimension of a hole 5 of the aforesaid flange 4.

The protruding parts 10 and 11 are provided at such distances that the distance between the bearing face 16 of the protruding part 10 up to the top wall 17 of the groove 13 of the protruding part 11 is equal to four times the centre distance between two flanges 4 in this embodiment.

Naturally, the pens 12 and 15 will be situated in each other's prolongation.

The use of the scaffold ladder 1 is very simple and as follows.

When building or when using the scaffold 1, the scaffold ladder 6 is provided in a hole 5 of a flange 4 of a vertical scaffold element 2, with the lower fixed pen 12 directed downward, after which the top protruding part 11 is slid with the groove 13 over a flange 4, such that the wedge-shaped pen 15 can be provided in the passage 14 of the protruding part 11 and in a hole 5 of a flange of the same vertical scaffold element 2, to thus lock the scaffold ladder 6.

In order to avoid that the wedge-shaped pen 15 might get lost, this pen 15 could be connected to the vertical support 7 by means of a little cable or the like.

According to yet another embodiment, a protruding part 10 can be provided with a fixed pen 12 at the top, and a protruding part 11 with a removable pen 14 at the bottom.

Finally, also two protruding parts 10 could be applied, but there would be no lock in this case, which is to be avoided most of the time.

The present invention is by no means limited to the above-described embodiments given as an example and represented in the accompanying drawings; on the contrary, such a scaffold ladder according to the invention can be made in all sorts of variants while still remaining within the scope of the invention.

1. A scaffold ladder, that consists of a vertical support provided with rungs on the one hand, and with protruding parts or hook elements on the other hand which can co-operate with erected scaffold elements.

2. The scaffold ladder according to claim 1, whereby on the support, at regular distances from one another, are provided V-shaped brackets whereby, between the far ends of these brackets, the above-mentioned rungs are fixed.

3. The scaffold ladder according to claim 1, wherein at least one of the aforesaid hook elements is provided with a downward directed pen which can co-operate with a hole of a traditional flange provided on a vertical scaffold element.

4. The scaffold ladder according to claim 3, wherein both hook elements are provided with a downward directed pen.

5. The scaffold ladder according to claim 4, wherein the pens of the hook elements have different lengths.

6. The scaffold ladder according to claim 3, wherein the pen or pens is, are wedge-shaped respectively.

7. The scaffold ladder according to claim 3, wherein the hook elements are provided on the above-mentioned support.

8. The scaffold ladder according to claim 3, wherein the second hook element has a groove whose width is somewhat larger than the thickness of the aforesaid flange.

9. The scaffold ladder according to claim 8, wherein a vertical wedge-shaped passage is provided in the protruding part or hook element which has a cross dimension at the height of the above-mentioned groove which is more or less equal to the cross dimension of a hole of an above-mentioned flange.

10. The scaffold ladder according to claim 9, wherein a wedge-shaped pen can work in conjunction with the afore-said passage, with a hole in a flange respectively.

11. The scaffold ladder according to claim 1, wherein the protruding part or hook element is situated at the bottom of the support, and in that another protruding part or hook element is situated at the top of the support.
